(19) United States
(12) Patent Application Publication
(10) Pub. No.: US 2009/0263653 A1
(43) Pub. Date: Oct. 22, 2009

(54) OPTICAL LAMINATES, POLARIZING PLATES AND IMAGE DISPLAY DEVICES

(76) Inventors: Kana YAMAMOTO, Tokyo (JP); Kiyoshi ITOH, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/238,816

(22) Filed: Sep. 26, 2008

(30) Foreign Application Priority Data
Sep. 28, 2007 (JP) 2007-256400
Sep. 18, 2008 (JP) 2008-238771

(51) Int. Cl. B32B 17/08; B32B 5/16; B05D 3/02

(52) U.S. Cl. 428/340; 428/426; 427/387

(57) ABSTRACT

The invention provides an optical laminate comprising an optically transparent base and a silica particle-containing antiglare layer, wherein the silica particles have a dielectric constant of less than 4.0, which optical laminate is provided with excellent optical characteristics and with suitable aggregation of silica particles even when silica particles are present in the antiglare layer.

### BACKGROUND OF THE INVENTION

1. Field of the Invention

The present invention relates to optical laminates, a process for their production, to polarizing plates provided with the optical laminates and to image display devices provided with any of the foregoing.

2. Related Background Art

In image display devices such as cathode ray tube (CRT) displays, liquid crystal displays (LCD), plasma displays (PDP) and electroluminescence displays (ELD), the outermost surfaces are provided with optical laminates composed of functional layers that perform various functions. Such optical laminates include known types having a laminated structure comprising functional layers such as an antiglare layer and a low refractive index layer, for example, in that order over a base, wherein the functional layers include fine particles as an antiglare agent (see Patent documents 1 and 2, for example). Excellent antiglare performance is provided in those types.

Silica particles are ordinarily used as the antiglare agent in the antiglare layers of such optical laminates, and antiglare layers containing silica particles as the antiglare agent are formed, for example, by coating the base with an antiglare layer forming resin composition containing silica particles and a curable resin.

However, when an optical laminate is formed using an antiglare layer forming resin composition containing silica particles as the antiglare agent, the dispersed stability of the silica particles in the antiglare layer forming resin composition is reduced with the result of aggregation of the silica particles, thereby lowering the optical characteristics of the antiglare layer which is formed.

[Patent document 1] Japanese Unexamined Patent Publication No. 2007-090717
[Patent document 2] Japanese Unexamined Patent Publication No. 2006-267556

### SUMMARY OF THE INVENTION

### Problems to be Solved by the Invention

In light of the current situation described above, it is an object of the present invention to provide an optical laminate with excellent optical characteristics, employing an antiglare layer forming resin composition for formation of a silica particle containing antiglare layer, wherein the silica particles are suitably aggregated and the composition has excellent dispersion stability.

### Means for Solving the Problems

The invention provides an optical laminate comprising an optically transparent base and an antiglare layer containing silica particles, wherein the silica particles have a dielectric constant of less than 4.0.

The silica particles preferably have a specific surface area of no greater than 2000 m²/g.

The silica particles are also preferably amorphous silica particles.

The content of the silica particles is preferably 10-50 parts by mass based on 100 parts by mass of the resin component in the antiglare layer.

The invention further provides an image display device comprising an optical laminate on an outermost surface thereof.

The invention still further provides a polarizing plate comprising a polarizing element, and the aforementioned optical laminate on the polarizing element surface.

The invention still further provides an image display device comprising the aforementioned optical laminate or polarizing plate on an outermost surface. thereof

In addition, the invention provides a process for producing an optical laminate with improved optical characteristics, comprising an optically transparent base and an antiglare layer containing silica particles, the process comprising the following steps (a)-(e):

(a) a step of adjusting the dielectric constant of the silica particles to less than 4.0;

(b) a step of dispersing and mixing the silica particles together with a binder resin and other components as desired to prepare an antiglare layer forming composition, the composition having reduced electrostatic attraction between the silica particles and controlled aggregation of the silica particles;

(c) a step of providing an optically transparent base;

(d) a step of coating the antiglare layer forming composition prepared in step (b) onto the optically transparent base to form a coated film; and

(e) a step of drying and curing the coated film to obtain an optical laminate,

wherein the obtained optical laminate is provided with superior black reproducibility and antiglare property.

Preferably in step (a), hollow silica particles are used as the silica particles and the dielectric constant of the silica particles is adjusted to less than 4.0 by varying the void percentage.

Also preferably in step (a), the dielectric constant of the silica particles is adjusted to less than 4.0 by doping the silica particles.

In addition, in step (a), the dielectric constant of the silica particles is preferably adjusted to less than 4.0 by chemically modifying the surfaces of the silica particles.

The surface chemical modification of the silica particles is more preferably hydrophobizing surface chemical treatment using a silicone material.

The present invention will now be explained in greater detail.

According to the invention, curable resin precursors such as monomers, oligomers and prepolymers will collectively be referred to as “resin(s)”, unless otherwise specified.

The optical laminate of the invention has a silica particle containing antiglare layer on an optically transparent base.

The silica particles have a dielectric constant of not less than 1.5 and less than 4.0. The following is conjectured to be the reason for the excellent optical characteristics exhibited by the optical laminate of the invention which has a silica particle containing antiglare layer.

Specifically, conventional optical laminates exhibit high antiglare performance by the presence of added silica particles. However, since commonly used conventional silica particles generally have high dielectric constant, they have tended to aggregate in the antiglare layer forming resin composition. The silica particles, therefore, fail to be uniformly dispersed in the antiglare layer, and it is thought that the optical characteristics of optical laminates formed in this manner have been lowered as a result.

An optical laminate according to the invention, on the other hand, employs silica particles in the antiglare layer that exhibit a dielectric constant in the specified range, whereby electrostatic attraction between the silica particles is reduced and the silica particles aggregate to a suitable degree so that excellent optical characteristics are exhibited.

The silica particles have a dielectric constant of less than 4.0. If it is 4.0 or greater, the silica particles will tend to aggregate more readily, thus lowering the optical characteristics. The dielectric constant is preferably as low as possible. The current lower limit achievable for dielectric constant is 1.5, and it is more preferably 2.0. The upper limit for the dielectric constant is preferably 3.3 and more preferably 3.0.

The dielectric constant of the silica particles may be measured for the silica particles themselves, for an ink composition containing the silica particles, or for a film of a cured optical laminate obtained after using and coating the composition. The method employed may be a probe method, open resonator method, perturbation cavity resonance method, propagation delay method or ellipsometry method, selected as appropriate for the range of the dielectric constant. When the object of measurement is in the form of a gel or liquid, a special measuring cell may be used for conduction to determine the dielectric constant. When the object of measurement is a cured film, a current may be passed through the optical laminate with the layer containing the silica particles as the outermost surface, to determine the dielectric constant. The dielectric constant can be determined in a more satisfactory manner by cutting out only the layer containing the silica particles in the cured film, by shaving or the like, for measurement.

The dielectric constant of the silica can be varied, for example, by changing the void percentage of the hollow silica particles, doping the silica particles, or chemically modifying the silica particle surfaces. Doping of the silica particles may be by non-metal element doping with fluorine, boron, phosphorus or the like, transition metal or metal element doping with titanium, bismuth, nickel or the like, or multi-element doping or oxide doping, with the doping element selected as appropriate and the doping concentration adjusted to vary the dielectric constant. For chemical modification, the dielectric constant may be varied by adjusting the extent of surface treatment or appropriately selecting the surface treatment agent during induction treatment of the silica particle surfaces, as described hereunder.

The silica particles preferably have a specific surface area of no greater than 2000 m²/g. A value exceeding 2000 m²/g will result in porosity and may render control of aggregation more difficult. The upper limit for the specific surface area is more preferably 1500 m²/g. The lower limit for the specific surface area is preferably 100 m²/g and more preferably 500 m²/g. The specific surface area may be measured using a BET specific surface area measuring apparatus (TRISTAR 3000 by Shimadzu Corp.).

The silica particle surfaces are preferably subjected to organic treatment. Using such silica particles can provide satisfactory dispersibility for the silica particles without increasing the viscosity of the antiglare layer forming resin composition described in detail hereunder.

There are no particular restrictions on the silica particles that are subjected to organic treatment, and they may be silica particles in crystal, sol, gel, hollow or porous form. They may even be amorphous silica particles. Commercially available silica particles may also be used as the silica particles to be subjected to the organic treatment, and for example, there may be mentioned amorphous silica (product of Dainichi Seika Co., Ltd.), AEROSIL (product of Degussa Ltd.) and colloidal silica (product of Nissan Chemical Industries, Ltd.).

The silica particles are preferably amorphous silica particles from the viewpoint of effectively forming irregular shapes and exhibiting an antiglare property.

Organic treatment includes methods of chemically bonding compounds to the silica particle surfaces, and physical methods involving infiltration into the voids within or between the particles without chemical bonding to the particle surfaces, and either of these types of methods may be employed.

Chemical treatment methods utilizing active groups on the silica particle surfaces such as hydroxyl or silanol groups are generally preferred from the viewpoint of treatment efficiency.

Hydrophobizing by such organic treatment may be accomplished by silylation with trimethylchlorsilane or the like, and the degree of hydrophobization can be adjusted by the amount of silylating agent added and/or the reaction temperature. In consideration of the dispersed stability of the silylated silica particles, the degree of hydrophobization is preferably about 50-90%.

The compound used for the treatment may be a silane-based, siloxane-based or silazane-based material which is highly reactive with the active groups on the silica particle surfaces. As examples there may be mentioned straight-chain alkyl monosubstituted silicone materials such as methyltrichlorosilane, branched alkyl monosubstituted silicone materials and polysubstituted straight-chain alkylsilicone compounds such as di-n-butyldichlorosilane or ethyldimethylchlorosilane, or polysubstituted branched alkylsilicone compounds. Straight-chain alkyl group or branched alkyl group monosubstituted or polysubstituted siloxane materials and silazane materials may also be effectively used.

Depending on the required function, the compound may also have a heteroatom, unsaturated bond group, cyclic bond group or aromatic functional group at the end or at an intermediate position of the alkyl chain. Since the alkyl groups in such compounds are hydrophobic, the surface of the material to be treated can be easily converted from a hydrophilic to a hydrophobic type, so that high affinity can be obtained even with polymer materials that lack affinity when untreated.

The content of the silica particles is preferably 10-50 parts by mass based on 100 parts by mass of the resin component in the antiglare layer. At less than 10 parts by mass, the antiglare property may be insufficient.

The lower limit for the content is more preferably 20 parts by mass. On the other hand, if it exceeds 50 parts by mass, the light transmittance may be reduced and the optical characteristics may be adversely affected when the material is used as an optical laminate. The upper limit for the content is more preferably 40 parts by mass.

The silica particles preferably have a mean particle size of 0.5-10.0 μm. At less than 0.5 μm, the cohesion will increase and control of aggregation may be impeded, while the antiglare property will also be reduced and a greater amount of addition may be necessary If it exceeds 10.0 μm, however, the light transmittance may be reduced and the optical characteristics may be adversely affected when the material is used as an optical laminate. The mean particle size is more preferably 1.0-5.0 μm.

The mean particle size is the value obtained by measurement with a Coulter counter.

The silica particles may be used alone or in combination with organic resin beads.

As organic resin beads, there may be mentioned polystyrene beads (refractive index: 1.60), melamine beads (refractive index: 1.57), acrylic beads (refractive index: 1.49-1.53), acryl-styrene beads (refractive index: 1.54-1.58), benzoguanamine-formaldehyde condensation product beads (refractive index: 1.66), melamine-formaldehyde condensation product (refractive index: 1.66), polycarbonate beads (refractive index: 1.57) and polyethylene beads (refractive index: 1.50). The organic resin beads preferably have hydrophobic groups on the surfaces, and examples of such beads include polystyrene beads, and acrylstyrene beads with easily modifiable refractive indexes.

The organic resin beads are preferably selected based on whether they have regular particle forms.

The organic resin beads preferably have a mean particle size of 0.5-10.0 μm. At less than 0.5 μm, the cohesion will increase and control of aggregation may be impeded, while an adequate antiglare property may not be obtained and a greater amount of addition may be necessary. If it exceeds 10.0 μm, however, the light transmittance may be reduced and the optical characteristics may be adversely affected when the material is used as an optical laminate. The mean particle size is more preferably 1.0-5.0 μm.

The mean particle size is the value obtained by measurement with a Coulter counter.

The content of the organic resin beads is preferably 10-50 parts by mass based on 100 parts by mass of the silica particles. At less than 10 parts by mass, an adequate antiglare property may not be obtained.

At greater than 50 parts by mass, the light transmittance may be reduced and the optical characteristics may be adversely affected when the material is used as an optical laminate. The lower limit for the content is more preferably 20 parts by mass. The upper limit is more preferably 40 parts by mass.

The antiglare layer preferably also contains a stain-proofing agent.

In conventional optical laminates, including a stain-proofing agent in the antiglare layer forming resin composition to impart an antifouling property has caused aggregation of the stain-proofing agent and silica particles, thereby lowering the optical characteristics of the antiglare layer.

However, the silica particles in the antiglare layer forming resin composition used to form the antiglare layer in an optical laminate according to the invention exhibit a dielectric constant in the specific range mentioned above, and therefore even if a stain-proofing agent is included in the antiglare layer forming resin composition, electrostatic attraction is suppressed and aggregation between the silica particles and stain-proofing agent is minimized. A high antifouling property is, therefore, required for the optical laminate, and even if a stain-proofing agent is added to the antiglare layer-forming resin composition, it is possible to obtain an optical laminate exhibiting a high antifouling property without lowering the optical characteristics.

The stain-proofing agent is not particularly restricted and any known one may be used, such as a fluorine-based compound and/or silicon-based compound. Specifically, there may be mentioned MEGAFAC F-482 by Dainippon Ink and Chemicals, Inc.

When the antiglare layer contains a stain-proofing agent, it is most preferably incorporated into the outermost surface. This will allow the optical laminate to more satisfactorily exhibit its antifouling property.

The antiglare layer containing the silica particles is a layer having an irregularly shaped surface, for the purpose of preventing reduction in visibility due to virtual images and reflection caused by external light, and surface glare (scintillation).

The method for forming an irregular shape in the surface may be a method in which irregularities are formed by a method in which they are formed by the silica particles and if desired also by the organic resin beads, or by embossing treatment. The antiglare layer may be formed by preparing an antiglare layer forming resin composition containing the silica particles, a binder resin, a solvent and other desired components.

The binder resin in the antiglare layer forming resin composition is preferably a transparent binder resin, and as examples there may be mentioned ionizing radiation-curable resins that harden with ultraviolet rays or an electron beam, and mixtures of ionizing radiation-curable resins and solvent-drying resins (resins such as thermoplastic resins that serve as coatings simply by drying the solvent added to adjust the solid content during coating), or thermosetting resins. Most preferred are ionizing radiation-curable resins.

As examples of ionizing radiation-curable resins, there may be mentioned compounds with one or more unsaturated bonds such as compounds with acrylate-based functional groups. As examples of compounds with one unsaturated bond, there may be mentioned ethyl (meth)acrylate, ethylhexyl (meth)acrylate, styrene, methylstyrene and N-vinylpyrrolidone. As examples of compounds with two or more unsaturated bonds, there may be mentioned reaction products of (meth)acrylates with polyfunctional compounds (for example, poly(meth)acrylates of polyhydric alcohols), such as polymethylolpropane tri(meth)acrylate, hexanediol (meth)acrylate, tripropyleneglycol di(meth)acrylate, diethyleneglycol di(meth)acrylate, pentaerythritol tri(meth)acrylate, dipentaerythritol hexa(meth)acrylate, 1,6-hexanediol di(meth)acrylate or neopentylglycol di(meth)acrylate. Throughout the present specification, the term “(meth)acrylate” means methacrylate and acrylate.

In addition to the compounds mentioned above, relatively low-molecular-weight resins with unsaturated double bonds, such as polyester resins, polyether resins, acrylic resins, epoxy resins, urethane resins, alkyd resins, spiroacetal resins, polybutadiene resins or polythiolpolyene resins may also be used as the ionizing radiation-curable resin.

The ionizing radiation-curable resin can also be used together with a solvent-drying resin. Using a solvent-drying resin therewith can effectively prevent defects in the coating film on the coated side and produce a more excellent luster quality. There are no particular restrictions on solvent-drying resins that may be used together with the ionizing radiation-curable resin, and thermoplastic resins may be used in most cases.

There are no particular restrictions on such thermoplastic resins, and as examples, there may be mentioned styrene-based resins, (meth)acrylic resins, vinyl acetate-based resins, vinyl ether-based resins, halogen-containing resins, alicyclic olefin-based resins, polycarbonate-based resins, polyester-based resins, polyamide-based resins, cellulose derivatives, silicone-based resins and rubber or elastomer compounds. These thermoplastic resins are preferably non-crystalline and soluble in organic solvents (especially solvents that can dissolve multiple polymers or curable compounds). From the viewpoint of film formability, transparency and weather resistance, styrene-based resins, (meth)acrylic resins, alicyclic olefin-based resins, polyester-based resins, cellulose derivatives (cellulose esters and the like) are especially preferred.

When the material of the optically transparent base in the optical laminate of the invention is a cellulose-based resin such as triacetylcellulose (TAC), preferred examples of thermoplastic resins are cellulose-based resins, including cellulose derivatives such as nitrocellulose, acetylcellulose, cellulose acetate propionate, ethylhydroxyethylcellulose, acetylbutylcellulose, ethylcellulose and methylcellulose. Using a cellulose-based resin can improve the transparency and the adhesiveness with the optically transparent base material or with other optionally formed layers such as antistatic layers. In addition to the aforementioned cellulose-based resins, there may be mentioned vinyl-based resins such as vinyl acetate and its copolymers, vinyl chloride and its copolymers or vinylidene chloride and its copolymers, acetal resins such as polyvinyl formal or polyvinyl butyral, acrylic-based resins such as acrylic resins and their copolymers or methacrylic resins and their copolymers, and polystyrene resins, polyamide resins, polycarbonate resins and the like.

Thermosetting resins to be used for the binder resin include phenol resins, urea resins, diallyl phthalate resins, melanin resins, guanamine resins, unsaturated polyester resins, polyurethane resins, epoxy resins, aminoalkyd resins, melamine-urea co-condensation resins, silicon resins, polysiloxane resins and the like.

The antiglare layer-forming resin composition preferably contains a photopolymerization initiator. As photopolymerization initiators, there may be mentioned acetophenones (for example, 1-hydroxy-cyclohexyl-phenyl-ketone marketed as IRGACURE 184 by Ciba Specialty Chemicals Co., Ltd.), benzophenones, thioxanthones, benzoins, benzoinmethyl ethers, aromatic diazonium salts, aromatic sulfonium salts, aromatic iodonium salts, metallocene compounds, benzoinsulfonic acid esters and the like. These may be used alone or in combinations of two or more.

The amount of photopolymerization initiator added is preferably 0.1-10 parts by mass based on 100 parts by solid mass of the ionizing radiation-curable resin.

Other optional components may be added as necessary to the antiglare layer-forming resin composition, in amounts that do not interfere with the effect of the invention. As such other optional components, there may be mentioned the aforementioned organic resin beads or stain-proofing agents, resins other than those mentioned above, surfactants, coupling agents, thickeners, anti-staining agents, coloring agents such as pigments or dyes, antifoaming agents, leveling agents, flame retardants, ultraviolet absorbers, infrared absorbers, tackifiers, polymerization inhibitors, antioxidants, surface modifiers and the like. These may be any known components that are commonly used in antiglare layers.

The antiglare layer-forming resin composition may be obtained, for example, by combining the aforementioned silica particles, binder resin, photopolymerization initiator and other optional components with a solvent and dispersing the mixture. The mixing and dispersion may be carried out using a paint shaker or bead mill.

As solvents there may be mentioned water, alcohols (for example, methanol, ethanol, isopropanol, butanol, benzyl alcohol), ketones (for example, acetone, methyl ethyl ketone, methyl isobutyl ketone, cyclohexanone), esters (for example, methyl acetate, ethyl acetate, propyl acetate, butyl acetate, methyl formate, ethyl formate, propyl formate, butyl formate), aliphatic hydrocarbons (for example, hexane, cyclohexane), halogenated hydrocarbons (for example, methylene chloride, chloroform, carbon tetrachloride), aromatic hydrocarbons (for example, benzene, toluene, xylene), amides (for example, dimethylformamide, dimethylacetamide, n-methylpyrrolidone), ethers (for example, diethyl ether, dioxane, tetrahydrofuran), ether alcohols (for example, 1-methoxy-2-propanol) and the like, although there is no limitation to these. One or more of these solvents may also be used in admixture as appropriate. Preferred among them are ketones, esters and aromatic hydrocarbons, and from the viewpoint of dispersibility, dispersion stability and safety, it is more preferred to use at least one type of ketone-based solvent, and even more preferred to use methyl ethyl ketone, methyl isobutyl ketone or cyclohexanone.

The antiglare layer is preferably formed by coating an optically transparent base with the antiglare layer-forming resin composition, drying it if necessary, and curing it by active energy beam irradiation. The method for coating the antiglare layer-forming resin composition may be a roll coating method, Meyer bar coating method, gravure coating method, die coating method or the like.

As active energy beam exposure, there may be mentioned ultraviolet ray or electron beam irradiation. As specific examples of ultraviolet ray sources, there may be mentioned light sources such as ultra-high-pressure mercury lamps, high-pressure mercury lamps, low-pressure mercury lamps, carbon arc lamps, blacklight fluorescent lamps, metal halide lamps and the like. The wavelength of the ultraviolet rays may be in a wavelength range of 190-380 nm. As specific examples of electron beam sources, there may be mentioned various types of electron beam accelerators such as a Cockoroft-Walton, van de Graaff, resonance transformer, insulated core transformer, linear, dynamitron or high-frequency type.

The thickness of the antiglare layer is preferably 1.0-7.5 μm.

At less than 1.0 μm, an adequate antiglare property may not be obtained. At greater than 7.5 μm, however, the light transmittance may be reduced and the optical characteristics may be adversely affected when the material is used as an optical laminate. The lower limit for the thickness is more preferably 2.0 μm. The upper limit is more preferably 3.0 μm.

The thickness of the antiglare layer may be measured by observation of a cross-section using a laser microscope, SEM or TEM. For example, measurement of the film thickness with a laser microscope may involve transmission observation of a cross-section of the antiglare layer using a confocal microscope (Leica TCS-NT by Leica Microsystems GmbH: 200-1000×magnification). More specifically, in order to obtain clear images without halation, observation may be made using a wet objective lens in a confocal microscope, placing approximately 2 ml of oil with a refractive index of 1.518 on the antiglare layer cross-section to remove the air space between the objective lens and antiglare layer cross-section. For each observation screen of the microscope, one point is measured at the Max and Min sections of the irregular surface of the film, for a total of 2 measurements. The measured values for 10 points (5 screens) are averaged to determine the mean film thickness. Five screens may also be observed for the cross-section using a SEM or TEM, and the mean value determined in the same manner.

The optically transparent base material is preferably transparent, smooth and heat resistant, with excellent mechanical strength. As specific examples of materials for formation of the optically transparent base, there may be mentioned thermoplastic resins including polyesters, (polyethylene terephthalate, polyethylene naphthalate, polybutylene terephthalate, polybutylene naphthalate), triacetylcellulose (TAC), cellulose diacetate, cellulose acetate butyrate, polyesters, polyamides, polyimides, polyethersulfones, polysulfones, polypropylene, polymethylpentene, polyvinyl chloride, polyvinylacetals, polyether ketones, polymethyl methacrylate, polycarbonates and polyurethanes, among which polyesters (polyethylene terephthalate, polyethylene naphthalate) and triacetylcellulose (TAC) are preferred.

Amorphous olefin polymer (Cyclo-Olefin-Polymer: COP) films having an alicyclic structure may also be used as the optically transparent base. Such base films may employ norbornane-based copolymers, monocyclic olefin-based copolymers, cyclic conjugated diene-based polymers, vinylalicyclic hydrocarbon-based copolymer resins and the like, and more specifically, there may be mentioned ZEONEX or ZEONOR (norbornane-based resin) by Zeon Corp., SUMILITE FS-1700 by Sumitomo Bakelite Co., Ltd., ARTON (modified norbornane-based resin) by JSR Corp., APEL (cyclic olefin copolymer) by Mitsui Chemicals, Inc., Topas (cyclic olefin copolymer) by Ticona and the OPTOREZ OZ-1000 series (alicyclic acrylic resins) by Hitachi Chemical Co., Ltd. Preferred as a triacetylcellulose substitute base material is the FV Series (low birefringence, low optical elastic modulus films) by Asahi Kasei Chemicals Corp.

The optically transparent base may be suitably used as a film with the high flexibility of the aforementioned thermoplastic resins, but for uses that require curability, these thermoplastic resins may also be used in the form of boards, or a glass board may be used.

The thickness of the optically transparent base is preferably 20-300 μm and more preferably 30-200 μm. If the optically transparent base is a board, the thickness may be in a range exceeding this range, such as 300-5000 μm. During formation of the antistatic layer, the base may be subjected to physical treatment such as corona discharge treatment or oxidation treatment, or coating with a coating agent such as an anchoring agent or primer, in order to improve the adhesive property.

The optical laminate of the invention preferably also has a low refractive index layer on the antiglare layer. The low refractive index layer is formed on the surface of the antiglare layer, and it has a lower refractive index than the antiglare layer. According to a preferred mode of the invention, the refractive index of the antiglare layer is 1.48 or greater and the refractive index of the low refractive index layer is less than 1.48 and preferably no greater than 1.45.

The low refractive index layer may be composed of 1) a material containing silica or magnesium fluoride, 2) a fluorine-based material as a low refractive index resin, 3) a fluorine-based material containing silica or magnesium fluoride or 4) a thin-film of silica or magnesium fluoride.

A fluorine-based material is a polymerizable compound containing at least one fluorine atom in the molecule, or its polymer. The polymerizable compound is not particularly restricted but is preferably one having, for example, a functional group that cures by ionizing radiation (ionizing radiation-curable group) or a curable reactive group such as a polar group that cures by heat (thermosetting polar group). Such compounds with reactive groups may also be used in combination.

Fluorine-containing monomers with ethylenic unsaturated bonds are widely used as polymerizable compounds having fluorine-containing ionizing radiation curable groups. More specifically, examples include fluoroolefins (fluoroethylene, vinylidene fluoride, tetrafluoroethylene, hexafluoropropylene, perfluorobutadiene, perfluoro-2,2-dimethyl-1,3-dioxole or the like, for example). As (meth)acryloyloxy-containing compounds, there may be mentioned (meth)acrylate compounds with fluorine atoms in the molecule, such as 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, α-trifluoromethyl (meth)acrylate or α-trifluoroethyl (meth)acrylate; and fluorine-containing polyfunctional (meth)acrylic acid ester compounds having in the molecule a C₁₋₁₄ fluoroalkyl, fluorocycloalkyl or fluoroalkylene group with at least 3 fluorine atoms, and at least two (meth)acryloyloxy groups.

Examples of polymerizable compounds with fluorine atom-containing thermosetting polar groups include 4-fluoroethylene-perfluoroalkylvinyl ether copolymers; fluoroethylene-hydrocarbon-based vinyl ether copolymers; and fluorine-modified forms of various resins such as epoxy, polyurethane, cellulose, phenol and polyimide resins. As examples of thermosetting polar groups, there are preferred hydrogen bond-forming groups such as hydroxyl, carboxyl, amino and epoxy groups. These are not only adhesive with coated films but have high affinity with inorganic ultrafine particles such as silica.

Examples of polymerizable compounds (fluorine-based resins) with both ionizing radiation curing groups and thermosetting polar groups include fully and partially fluorinated alkyl, alkenyl and aryl esters of acrylic or methacrylic acid, fully and partially fluorinated vinyl ethers, fully and partially fluorinated vinyl esters, and fully and partially fluorinated vinylketones.

As examples of polymers of the aforementioned fluorine atom-containing polymerizable compounds, there may be mentioned polymers of monomers or monomer mixtures including at least one fluorine-containing (meth)acrylate compound among the aforementioned polymerizable compounds with ionizing radiation curable groups; copolymers of at least one fluorine-containing (meth)acrylate compound with a (meth)acrylate compound containing no fluorine atom in the molecule, such as methyl (meth)acrylate, ethyl (meth)acrylate, propyl (meth)acrylate, butyl (meth)acrylate or 2-ethylhexyl (meth)acrylate; and fluorine monomer-containing homopolymers or copolymers such as fluoroethylene, vinylidene fluoride, trifluoroethylene, chlorotrifluoroethylene, 3,3,3-trifluoropropylene, 1,1,2-trichloro-3,3,3-trifluoropropylene or hexafluoropropylene.

Silicone-containing vinylidene fluoride copolymers obtained by including a silicone component in these copolymers may also be used as polymers of polymerizable compounds. Examples of silicone components for such compounds include (poly)dimethylsiloxane, (poly)diethylsiloxane, (poly)diphenylsiloxane, (poly)methylphenylsiloxane, alkyl-modified (poly)dimethylsiloxane, azo group-containing (poly)dimethylsiloxane, dimethylsilicone, phenyl methylsilicone, alkyl/aralkyl-modified silicone, fluorosilicone, polyether-modified silicone, fatty acid ester-modified silicone, methylhydrogen silicone, silanol group-containing silicone, alkoxy group-containing silicone, phenol group-containing silicone, methacryl-modified silicone, acryl-modified silicone, amino-modified silicone, carboxylic acid-modified silicone, carbinol-modified silicone, epoxy-modified silicone, mercapto-modified silicone, fluorine-modified silicone and polyether-modified silicone. Compounds with dimethylsiloxane structures are preferred among the above.

In addition to these, other fluorine-based materials that may be used include compounds obtained by reacting fluorinated compounds with at least one isocyanato group in the molecule and compounds with at least one isocyanato group-reacting functional group such as amino, hydroxyl or carboxyl in the molecule; and compounds obtained by reacting fluorine-containing polyols such as fluorine-containing polyether polyols, fluorine-containing alkyl polyols, fluorine-containing polyester polyols and fluorine-containing ε-caprolactone-modified polyols, with isocyanato group-containing compounds.

The low refractive index layer may be formed using a composition comprising the starting components (low refractive index layer forming composition). More specifically, a solution or dispersion containing the starting components (resin, etc.) and necessary additives (for example, “fine particles with voids” described hereunder, a polymerization initiator, antistatic agent, etc.) dissolved or dispersed in a solvent may be used as a low refractive index layer forming composition to form a coated film with the composition, and the coated film may be cured to obtain a low refractive index layer. As additives (such as polymerization initiators), there may be mentioned the same ones as for the antiglare layer, for example.

The solvents mentioned above for the antiglare layer may also be used, with methyl isobutyl ketone, cyclohexanone, isopropyl alcohol (IPA), n-butanol, t-butanol, diethylketone and PGME being preferred.

The method of preparing the composition may be according to a known method that allows uniform mixing of the components. For example, mixing may be accomplished using a known apparatus such as mentioned above for formation of the antiglare layer.

The method of forming the coating film may also be a known method. For example, any of the aforementioned methods for formation of the antiglare layer may be employed.

The curing method for the obtained coated film may be selected as appropriate depending on the content of the composition. For an ultraviolet curing composition, for example, the coated film may be irradiated with ultraviolet rays for curing.

For the low refractive index layer, “fine particles with voids” are preferably used as the low refractive index agent. “Fine particles with voids” can help maintain the antiglare layer strength while lowering the refractive index. According to the invention, “fine particles with voids” are fine particles having a structure with the fine particle interiors filled with gas and/or a porous structure containing a gas, and such fine particles have lower refractive indexes in inverse proportion to the gas occupancy ratio of the fine particles, compared to the refractive indexes of the original fine particles. The invention also encompasses fine particles that can form a nanoporous structure in at least part of the interior and/or surface, by the form, structure, aggregated state and dispersed state of the fine particles in the coating film interior. The low refractive index layer employing such fine particles can have its refractive index adjusted to 1.30-1.45.

As examples of inorganic fine particles with voids, there may be mentioned silica fine particles prepared by the method described in Japanese Unexamined Patent Publication No. 2001-233611. They may also be silica fine particles obtained by the methods described in Japanese Unexamined Patent Publication HEI No. 7-133105, Japanese Unexamined Patent Publication No. 2002-79616 and Japanese Unexamined Patent Publication No. 2006-106714. Because silica fine particles with voids are easy to produce and exhibit high hardness, they can improve the layer strength and allow adjustment of the refractive index to a range of about 1.20-1.45 when mixed with a binder to form the low refractive index layer. As particularly preferred examples of organic fine particles with voids, there may be mentioned hollow polymer fine particles prepared by the technique disclosed in Japanese Unexamined Patent Publication No. 2002-80503.

In addition to the aforementioned silica fine particles as fine particles allowing formation of a nanoporous structure in at least part of the coating film interior and/or surface, there may also be mentioned release materials that adsorb chemical substances onto packing columns and surface porous sections and are produced for an increased specific surface area, porous fine particles used to fix the catalyst, and dispersions or aggregates of hollow fine particles to be incorporated into heat insulating materials or low dielectric materials. Specifically, there may be used commercially available porous silica fine particle aggregates such as Nipsil or Nipgel, trade names of Nippon Silica Industries Co., Ltd., or particles with sizes within the preferred ranges of the invention from among the colloidal silica UPTM Series, trade name of Nissan Chemical Industries, Ltd., having a structure with silica fine particles linked in a chain fashion.

The mean particle size of the “fine particles with voids” is from 5 nm to 300 nm; preferably the lower limit is 8 nm or greater and the upper limit is 100 nm or smaller, and even more preferably the lower limit is 10 nm or greater and the upper limit is 80 nm or smaller. A mean particle size of the fine particles within these ranges can impart the antiglare layer with excellent transparency. The mean particle size is the value measured by a method such as dynamic light scattering. The fine particles with voids are generally used at about 0.1-500 parts by mass and preferably 10-200 parts by mass based on 100 parts by mass of the matrix resin in the low refractive index layer.

For formation of the low refractive index layer, the viscosity of the low refractive index layer-forming composition is preferably in a range of 0.5-5 cps (25° C.) and preferably 0.7-3 cps (25° C.), which will result in desirable coatability. This will allow formation of an antireflection film with excellent visible light transparency as a uniform thin-film without unevenness of application, while also producing a low refractive index layer with excellent adhesiveness for the base.

The resin curing means is the same as for the antiglare layer explained above. When heating means is used for curing, a thermopolymerization initiator that generates radicals and initiates polymerization of the polymerizable compound upon heating is preferably added to the fluorine-based resin composition.

The film thickness (nm) dA of the low refractive index layer preferably satisfies the following formula (I):

dA=mλ/(4 nA) (I)

(wherein nA represents the refractive index of the low refractive index layer, m represents a positive odd integer, preferably 1 and λ represents the wavelength in the range of preferably 480-580 nm).

According to the invention, the low refractive index layer preferably satisfies the following inequality (II):

120<nAdA<145 (II)

from the viewpoint of obtaining low reflectance.

In addition to the antiglare layer and low refractive index layer, if necessary, the optical laminate of the invention may also comprise an antifouling layer, antistatic layer, high refractive index layer or medium refractive index layer as an optional layer.

The antifouling layer, antistatic layer, high refractive index layer or medium refractive index layer may be formed by known methods for formation of such layers, with preparation of compositions containing commonly employed antifouling agents, high refractive index agents, medium refractive index agents, antistatic agents, resins and the like.

The optical laminate of the invention preferably has an irregularly-shaped surface. For the irregular shape, defining Sm as the mean spacing of irregularities on the outermost surface layer of the optical laminate, θa as the average inclination angle of the uneven sections and Rz as the ten-point average roughness of irregularities (where the definitions of Sm, θa and Rz are according to JIS B0601 1994), preferably Sm is from 40 μm to 600 μm, θa is from 0.3 to 5.0 and Rz is from 0.3 μm to 4.0 μm.

The measuring conditions in the surface roughness measuring instrument used to determine Sm, θa and Rz were as follows.

Surface roughness measuring instrument (Model SE-3400, product of Kosaka Laboratory, Ltd.)
(1) Surface Roughness Detecting Element Probe:
   Model SE2555N (2μ standard), product of Kosaka Laboratory, Ltd.
   (Tip curvature radius: 2 μm, apex angle: 90 degrees, material: diamond)
(2) Measuring Conditions in Surface Roughness Measuring Instrument:
   Reference length (cutoff value of roughness curve: λc): 0.8 mm
   Evaluation length (reference length (cutoff value λc)×5): 4.0 mm
   Probe feeding speed: 0.1 mm/s

The visible light transmittance of the optical laminate is preferably 90% or greater. At less than 90%, the color reproducibility may be impaired when it is fitted onto a display surface. The visible light transmittance is more preferably 95% or greater, and even more preferably 98% or greater.

The surface haze value of the optical laminate is preferably no greater than 10%. At greater than 10%, the color reproducibility may be impaired when it is fitted onto a display surface. The haze value is more preferably 0.2-5%. The surface haze is the value obtained by measurement using an HM-150 Hazemeter (product of Murakami Color Research Laboratory Co., Ltd.).

The interior haze value of the optical laminate is preferably no greater than 70%. An interior haze value within this range will have the effect of improving surface glare (scintillation) when the optical laminate of the invention is used for an LCD or the like.

The surface haze and interior haze values are obtained by the following methods. Specifically, a resin (including resin components such as monomers or oligomers) such as pentaerythritol triacrylate is diluted with toluene or the like over the irregularities of the upper surface layer of the optical laminate (for example, the antiglare layer or low refractive index layer) to a solid content of 60%, and this is coated with a wire bar to a dry film thickness of 8 μm. This crushes the surface irregularities on the upper surface layer to form a flat layer. However, when the presence of a leveling agent in the composition used to form the upper surface layer causes cissing of recoating agents and inhibits wetting, the antiglare film may be pretreated with hydrophilic treatment by saponification (immersion in a 2 mol/l NaOH (or KOH) solution at 55° C. for 3 minutes, followed by rinsing and complete removal of water droplets with a Kimwipe, and then 1 minute of drying in an oven at 50° C.). The surface-flattened film has only interior haze, with no haze due to surface irregularities. The haze may therefore be determined in terms of interior haze alone. The value of the haze of the original optical laminate (total haze) minus the interior haze is determined as the haze due to surface irregularities alone (surface haze).

The invention further provides a polarizing plate comprising a polarizing element, where the polarizing plate is a polarizing plate comprising the optical laminate described above on a polarizing element surface.

There are no particular restrictions on the polarizing element, and for example, there may be used polyvinyl alcohol films, polyvinyl formal films, polyvinylacetal films and ethylene-vinyl acetate copolymer-based saponified films dyed with iodine or the like and stretched. For lamination of a polarizing element with the optical laminate of the invention, it is preferred to use a saponified optically transparent base. Saponification can result in satisfactory adhesiveness and an antistatic effect.

The invention also provides an image display device comprising an optical laminate or polarizing plate on the outermost surface.

As image display devices there may be mentioned LCD, PDP, FED, ELD (organic EL, inorganic EL) and CRT devices.

An LCD, as a typical example of an image display device, has a transparent display member and a light source device that irradiates from its back side. When the image display device of the invention is a LCD, an optical laminate or polarizing plate according to the invention is formed on the surface of the transparent display member.

When the invention is a liquid crystal display device having the aforementioned optical laminate, the light source of the light source device irradiates from under the optical laminate. A phase contrast panel may be inserted between the liquid crystal display element and polarizing plate in an STN type liquid crystal display device. An adhesive layer may also be provided between the respective layers of the liquid crystal display device if necessary.

A PDP, as an example of an image display device, comprises a surface glass panel and a back glass panel situated opposite the surface glass panel with discharge gas enclosed between them. When the image display device of the invention is a PDP, the aforementioned optical laminate is provided on the surface of the surface glass panel or its front panel (glass panel or film sheet).

The image display device may be an image display device such as an ELD device wherein zinc sulfide or diamine substance (phosphor) that emits light upon application of voltage is vapor deposited on the glass panel and the voltage applied to the panel is controlled for display, or a CRT that converts electrical signals to light to form viewable images. In this case, the optical laminate is provided on the outermost surface of the display device or the surface of its front panel.

The optical laminate of the invention may be used for display in television sets, computers, word processors and the like. It is particularly suitable for use on the surfaces of high definition images in displays such as CRT, liquid crystal panel, PDP, ELD or other displays.

### Effect of the Invention

The optical laminate of the invention having the construction described above exhibits excellent antiglare, antifouling and color reproducibility properties. It can, therefore, be suitably applied in cathode ray tube (CRT) displays, liquid crystal displays (LCD), plasma displays (PDP), electroluminescence displays (ELD) and the like.

### DESCRIPTION OF THE PREFERRED EMBODIMENTS

The invention will now be explained in greater detail through examples and comparative examples; however, the scope of the invention will not be construed as being limited only to these examples. Unless otherwise specified, the “parts” and “%” values are based on mass.

### (Preparation of Amorphous Silica Particles)

The amorphous silica used in the examples and comparative examples was produced by a wet process involving neutralization reaction of sodium silicate and sulfuric acid (described in Japanese Patent No. 1781081, Japanese Patent No. 1409252, Japanese Patent No. 2667071 and Japanese Patent No. 3719687, for example) The obtained amorphous silica particles were subjected to hydrophobizing surface chemical treatment with trimethylchlorsilane, and the degree of hydrophobization was adjusted to within a range of 50-90% to obtain amorphous silica particles with different dielectric constants.

### (Measurement of Dielectric Constant)

One dispersion was prepared for each of the amorphous silica particles used in the examples and comparative examples, to prepare samples for measurement of the dielectric constant.

The dielectric constant was measured using a Model 1260 impedance analyzer (2-terminal method) by Solartron, Ltd., with a frequency range of 1 KHz-100 KHz and a measuring temperature of 25° C.

Instead of measurement in a dispersed state as described above, the dielectric constant may also be measured by coating and curing the composition into an optical laminate and then cutting out only the silica-containing layer section of the cured film by shaving or the like. In this case, a method may be carried out in which gold is sputtered onto both sides of the cut out film, silver paste is suitably adhered around the film and a current is passed through it, after which it is dried under reduced pressure while heating at 80° C. to prepare a sample for measurement of the dielectric constant. When a cured film is formed and different types of amorphous silica particles are present, their average value is used.

### (Preparation of Antiglare Layer Forming Resin Compositions)

### PREPARATION EXAMPLE 1

### Preparation of Antiglare Layer Forming Resin Composition 1

Ultraviolet curing resin:

| | | |
|---|---|---|
| Pentaerythritol triacrylate (FETA) | 20 | parts by mass |
| (refractive index: 1.51) | | |
| Cellulose acetate propionate | 0.25 | parts by mass |
| (molecular weight: 50,000) | | |

Photocuring initiator:

| | | |
|---|---|---|
| IRGACURE 184 (product of Ciba Specialty | 1.2 | parts by mass |
| Chemicals Co., Ltd.): | | |
| IRGACURE 907 (product of Ciba Specialty | 0.2 | parts by mass |
| Chemicals Co., Ltd.): | | |
| Amorphous silica particles (dielectric | 1.24 | parts by mass |
| constant: 2.5) (Mean particle size: 1.0 μm, | | |
| surface hydrophobization treatment with | | |
| silane coupling agent) | | |
| Silicone-based leveling agent | 0.013 | parts by mass |
| Toluene | 34.0 | parts by mass |
| Methyl isobutyl ketone | 8.5 | parts by mass |

The materials listed above were thoroughly mixed to prepare a composition. The composition was filtered with a polypropylene filter having a pore size of 30 μm, to prepare antiglare layer forming resin composition 1 with a solid content of 35%.

### PREPARATION EXAMPLE 2

### Preparation of Antiglare Layer Forming Resin Composition 2

Ultraviolet curing resin:

| | | |
|---|---|---|
| Pentaerythritol triacrylate (PETA) | 38 | parts by mass |
| (refractive index: 1.51) | | |
| Cellulose acetate propionate | 0.76 | parts by mass |
| (molecular weight: 50,000) | | |

Photocuring initiator:

| | | |
|---|---|---|
| IRGACURE 184 (product of Ciba Specialty | 2.3 | parts by mass |
| Chemicals Co., Ltd.): | | |
| IRGACURE 907 (product of Ciba Specialty | 0.4 | parts by mass |
| Chemicals Co., Ltd.): | | |
| Amorphous silica particles (mean particle | 1.16 | parts by mass |
| size: 1.5 μm, dielectric constant: 2.5) | | |
| Amorphous silica particles (mean particle | 7.27 | parts by mass |
| size: 1.0 μm, dielectric constant: 3.0) | | |
| Silicone-based leveling agent | 0.079 | parts by mass |
| Toluene | 60.2 | parts by mass |
| Methyl isobutyl ketone | 14.1 | parts by mass |

The materials listed above were thoroughly mixed to prepare a composition. The composition was filtered with a polypropylene filter having a pore size of 30 μm, to prepare antiglare layer-forming resin composition 2 with a solid content of 38.5%.

### PREPARATION EXAMPLE 3

### Preparation of Antiglare Layer Forming Resin Composition 3

Ultraviolet curing resin:

| | | |
|---|---|---|
| Pentaerythritol triacrylate (PETA) | 2.20 | parts by mass |
| (refractive index: 1.51) | | |
| Isocyanuric acid-modified diacrylate M215 | 1.21 | parts by mass |
| (product of Nippon Kayaku Co., Ltd., | | |
| refractive index: 1.51) | | |
| Polymethyl methacrylate (molecular | 0.34 | parts by mass |
| weight: 75,000) | | |

Photocuring initiator:

| | | |
|---|---|---|
| IRGACURE 184 (product of Ciba Specialty | 0.22 | parts by mass |
| Chemicals Co., Ltd.): | | |
| IRGACURE 907 (product of Ciba Specialty | 0.04 | parts by mass |
| Chemicals Co., Ltd.): | | |

Translucent primary particles:

| | | |
|---|---|---|
| Monodisperse acrylic beads (particle size: | 0.82 | parts by mass |
| 9.5 μm, refractive index: 1.535) | | |

Translucent secondary particles:

| | | |
|---|---|---|
| Amorphous silica ink | 1.73 | parts by mass |
| (Mean particle size: 1.5 μm, solid content: | | |
| 60%, dielectric constant: 2.5) | | |

Leveling agent:

| | | |
|---|---|---|
| Silicone-based leveling agent | 0.02 | parts by mass |

Solvent:

| | | |
|---|---|---|
| Toluene | 5.88 | parts by mass |
| Cyclohexanone | 1.55 | parts by mass |

The materials listed above were thoroughly mixed to prepare a composition with a solid content of 40.5%. The composition was filtered with a polypropylene filter having a pore size of 30 μm, to prepare antiglare layer forming resin composition 3.

### PREPARATION EXAMPLE 4

### Preparation of Antiglare Layer Forming Resin Composition 4

Antiglare layer forming resin composition 4 was prepared in exactly the same manner with the same blending ratio, except that the amorphous silica particles (dielectric constant: 2.5) of antiglare layer resin composition 1 were replaced with different amorphous silica particles (dielectric constant: 4.0).

### PREPARATION EXAMPLE 5

### Preparation of Antiglare Layer Forming Resin Composition 5

Antiglare layer forming resin composition 5 was prepared in exactly the same manner with the same blending ratio, except that the amorphous silica particles (mean particle size: 1.5 μm, dielectric constant: 2.5) of antiglare layer forming resin composition 2 were replaced with a material of different amorphous silica particles (mean particle size: 1.5 μm, dielectric constant: 4.0).

### PREPARATION EXAMPLE 6

### Preparation of Antiglare Layer Forming Resin Composition 6

Antiglare layer forming resin composition 6 was prepared in exactly the same manner with the same blending ratio, except that the amorphous silica ink (mean particle size: 1.5 μm, solid content: 60%, dielectric constant: 2.5) of antiglare layer forming resin composition 3 was replaced with a different amorphous silica ink material (mean particle size: 1.5 μm, solid content: 60%, dielectric constant: 4.0).

### PREPARATION EXAMPLE 7

### Preparation of Antiglare Layer Forming Resin Composition 7

Antiglare layer forming resin composition 7 was prepared in exactly the same manner with the same blending ratio, except that the amorphous silica ink (mean particle size: 1.5 μm, solid content: 60%, dielectric constant: 2.5) of antiglare layer forming resin composition 3 was replaced with a different amorphous silica ink material (mean particle size: 1.5 μm, solid content: 50%, dielectric constant: 1.0).

### PREPARATION EXAMPLE 8

### Preparation of Antiglare Layer Forming Resin Composition 8

Antiglare layer forming resin composition 8 was prepared in exactly the same manner with the same blending ratio, except that the amorphous silica ink (mean particle size: 1.5 μm, solid content: 60%, dielectric constant: 2.5) of antiglare layer forming resin composition 3 was replaced with a different amorphous silica ink material (mean particle size: 1.5 μm, solid content: 50%, dielectric constant: 1.5).

### PREPARATION EXAMPLE 9

### Preparation of Antiglare Layer Forming Resin Composition 9

Antiglare layer forming resin composition 9 was prepared in exactly the same manner with the same blending ratio, except that the amorphous silica ink material (mean particle size: 1.5 μm, solid content: 60%, dielectric constant: 2.5) of antiglare layer forming resin composition 3 was replaced with a different amorphous silica ink material (mean particle size: 1.5 μm, solid content: 50%, dielectric constant: 2.0).

### PREPARATION EXAMPLE 10

### Preparation of Antiglare Layer Forming Resin Composition 10

Antiglare layer forming resin composition 10 was prepared in exactly the same manner with the same blending ratio, except that the amorphous silica ink material (mean particle size: 1.5 μm, solid content: 60%, dielectric constant: 2.5) of antiglare layer forming resin composition 3 was replaced with a different amorphous silica ink material (mean particle size: 1.5 μm, solid content: 50%, dielectric constant: 3.0).

### PREPARATION EXAMPLE 11

### Preparation of Antiglare Layer Forming Resin Composition 11

Antiglare layer forming resin composition 11 was prepared in exactly the same manner with the same blending ratio, except that the amorphous silica ink material (mean particle size: 1.5 μm, solid content: 60%, dielectric constant: 2.5) of antiglare layer forming resin composition 3 was replaced with a different amorphous silica ink material (mean particle size: 1.5 μm, solid content: 50%, dielectric constant: 3.3).

### PREPARATION EXAMPLE 12

### Preparation of Low Refractive Index Layer Forming Composition

| | | |
|---|---|---|
| Hollow silica slurry | 9.57 | parts by mass |
| (IPA MIBK dispersion, solid content: | | |
| 20%, particle size: 50 nm) | | |
| Pentaerythritol triacrylate PET30 | 0.981 | parts by mass |
| (Ultraviolet curing resin, product of | | |
| Nippon Kayaku Co., Ltd.) | | |
| AR110 | 6.53 | parts by mass |
| (Fluorine polymer, solid content: | | |
| 15%, MIBK solution, product of Daikin | | |
| Industries, Ltd.) | | |
| IRGACURE 184 | 0.069 | parts by mass |
| (Photocuring initiator, product of | | |
| Ciba Specialty Chemicals Co., Ltd.) | | |
| Silicone-based leveling agent | 0.157 | parts by mass |
| Propyleneglycol monomethyl ether (PGME) | 28.8 | parts by mass |
| Methyl isobutyl ketone | 53.9 | parts by mass |

After thoroughly mixing the above components, they were filtered with a polypropylene filter having a pore size of 10 μm, to prepare a low refractive index layer-forming composition with a solid content of 4%. The composition had a refractive index of 1.40.

### EXAMPLE 1

### Formation of Antiglare Layer

Using a triacetylcellulose film (TD80U, product of Fuji Film Corp.; thickness: 80 μm) as the transparent base material, the film was coated with antiglare layer forming resin composition 8 using a winding rod (Meyer bar) #6 for coating and then heated and dried for one minute in an oven at 70° C. to evaporate off the solvent component, after which it was irradiated with ultraviolet rays at an exposure dose of 100 mJ in a nitrogen atmosphere (oxygen concentration: ≦200 ppm) to cure the coated film and form an antiglare layer.

### Lamination of Low Refractive Index Layer

The antiglare layer was coated with the low refractive index layer forming composition prepared in Preparation Example 12 using a winding rod (Meyer bar) #2 for coating, and then heated and dried for one minute in an oven at 70° C. to evaporate off the solvent component, after which it was irradiated with ultraviolet rays at an exposure dose of 100 mJ in a nitrogen atmosphere (oxygen concentration: ≦200 ppm) to cure the coated film for lamination of a low refractive index layer, thus obtaining optical laminate 1.

### EXAMPLE 2

Optical laminate 2 was obtained in the same manner as Example 1, except that antiglare layer forming resin composition 8 was replaced with antiglare layer forming resin composition 9.

### EXAMPLE 3

Optical laminate 3 was obtained in the same manner as Example 1, except that antiglare layer forming resin composition 8 was replaced with antiglare layer forming resin composition 1.

### EXAMPLE 4

Optical laminate 4 was obtained in the same manner as Example 1, except that antiglare layer forming resin composition 8 was replaced with antiglare layer forming resin composition 2

### EXAMPLE 5

Using the same triacetatecellulose film of Example 1 (TD80U, product of Fuji Film Corp.; thickness: 80 μm) as the transparent base material, the film was coated with antiglare layer forming resin composition 3 using a winding rod (Meyer bar) #14 for coating and then heated and dried for 1 minute in an oven at 70° C. to evaporate off the solvent component, after which it was irradiated with ultraviolet rays at an exposure dose of 30 mJ to cure the coated film and form an antiglare layer.

### Lamination of Low Refractive Index Layer

The antiglare layer was coated with the low refractive index layer forming composition prepared in Preparation Example 12 using a winding rod (Meyer bar) #2 for coating, and then heated and dried for one minute in an oven at 70° C. to evaporate off the solvent component, after which it was irradiated with ultraviolet rays at an exposure dose of 100 mJ in a nitrogen atmosphere (oxygen concentration: ≦200 ppm) to cure the coated film for lamination of a low refractive index layer, thus obtaining optical laminate 5.

### EXAMPLE 6

Optical laminate 6 was obtained in the same manner as Example 1, except that antiglare layer forming resin composition 8 was replaced with antiglare layer forming resin composition 10.

### EXAMPLE 7

Optical laminate 7 was obtained in the same manner as Example 1, except that antiglare layer forming resin composition 8 was replaced with antiglare layer forming resin composition 11.

### COMPARATIVE EXAMPLE 1

Optical laminate 8 was obtained in the same manner as Example 1, except that antiglare layer forming resin composition 8 was replaced with antiglare layer forming resin composition 4.

### COMPARATIVE EXAMPLE 2

Optical laminate 9 was obtained in the same manner as Example 1, except that antiglare layer forming resin composition 8 was replaced with antiglare layer forming resin composition 5.

### COMPARATIVE EXAMPLE 3

Optical laminate 10 was obtained in the same manner as Example 5, except that antiglare layer forming resin composition 3 was replaced with antiglare layer forming resin composition 6.

### Evaluation Tests

The following evaluations were conducted, giving the results shown in Table 1.

### Evaluation 1: Optical Characteristics Test, Surface Shape

The optical laminates of the examples and comparative examples were used for measurement of the total haze of the optical laminate Ha, the interior haze of the optical laminate Hi, the Hi/Ha value and the reflection Y value (5 degree reflection), according to the definitions in the present specification.

The reflectance was measured using a spectrometer (UV-3100PC, product of Shimadzu Corp.) equipped with a 5° C. specular reflection measuring apparatus. The reflectance was recorded as the minimum value (minimum reflectance) near a wavelength of 550 nm.

### Evaluation 2: Black Reproducibility Test (Light Room Environment)

After attaching a cross Nicol polarizing plate onto the film side and the opposite side of each of the optical laminates of the examples and comparative examples, evaluation (by visual observation from an angle of about 45°, 50 cm above the sample surface) was made under 30 W three band fluorescence (irradiated from a direction 45° with respect to the antiglare layer), and the black reproducibility (whether black appeared black) was evaluated in detail based on the following scale. A cross Nicol polarizing plate was used as a black reference sample for comparison of the black color.

### Evaluation Scale

⊚: Total black reproduction. (no opalescence)
◯: Almost total black reproduction. (slight opalescence, but an acceptable level)
Δ: Inadequate black reproduction. (some opalescence and noticeable level)
X: No black reproduction. (strong opalescence, unacceptable level)

### Evaluation 3: Antiglare Property Evaluation Test

The back sides of each of the optical laminates obtained in the examples and comparative examples were subjected to adhesive treatment and attached to black acryl boards for use as evaluation samples. A black/white striped board with a 20 mm width was prepared, and the stripes were transferred onto each of the aforementioned samples (with the sample surface inclined about 30 degrees upward), at an angle of 20 degrees from the normal to the sample surface. The illuminance on the sample surface was 250 lx, and the (white) luminance of the stripes was 65 cd/m². The distance between the striped board and the sample was 1.5 m, and the distance between the sample and an observer was 1 m. Evaluation was made as follows, based on the appearance of the stripes when viewed by the observer.

### Evaluation Scale

⊚: No stripes visible, satisfactory antiglare property.
◯: Stripes visible, but an acceptable level.
X: Recognizable stripes.

TABLE 1

| | | | | | | | | Comp. | Comp. | Comp. |
|---|---|---|---|---|---|---|---|---|---|---|
| | Example 1 | Example 2 | Example 3 | Example 4 | Example 5 | Example 6 | Example 7 | Ex. 1 | Ex. 2 | Ex. 3 |
| Silica dielectric | 1.5 | 2 | 2.5 | 2.5 (1.5 μm) | 2.5 | 3 | 3.3 | 4 | 4.0 (1.5 μm) | 4 |
| constant | | | | 3.5 (1.0 μm) | | | | | 3.5 (1.0 μm) | |
| Specific surface | 800 | 900 | 900 | 1300 | 1000 | 1200 | 1200 | 1100 | 1500 | 2100 |
| area | | | | (total) | | | | | (total) | |
| Ha | 2.9 | 3.3 | 3.9 | 3.6 | 5.7 | 6 | 12 | 21.1 | 19.3 | 23.5 |
| Hi | 1.1 | 1.2 | 1.6 | 1.3 | 1.9 | 2.2 | 6.3 | 9.8 | 10.1 | 12.2 |
| Hi/Ha | 0.38 | 0.36 | 0.41 | 0.36 | 0.33 | 0.37 | 0.53 | 0.46 | 0.52 | 0.51 |
| Reflection Y | 2.23 | 2.22 | 2.26 | 2.47 | 3.02 | 2.99 | 3.54 | 3.78 | 4.19 | 4.48 |
| value | | | | | | | | | | |
| Black | ◯ | ◯ | ⊚ | ⊚ | ⊚ | ◯ | ◯ | Δ | Δ | X |
| reproducibility | | | | | | | | | | |
| test (light room) | | | | | | | | | | |
| Antiglare | ◯ | ◯ | ⊚ | ⊚ | ⊚ | ◯ | ◯ | X | X | X |
| property | | | | | | | | | | |
| evaluation test | | | | | | | | | | |
| (visual | | | | | | | | | | |
| evaluation) | | | | | | | | | | |

### INDUSTRIAL APPLICABILITY

An optical laminate according to the invention can be suitably applied in a cathode ray tube (CRT) display, liquid crystal display (LCD), plasma display (PDP), electroluminescence display (ELD) or the like.

1. An optical laminate comprising an optically transparent base and an antiglare layer containing silica particles, wherein the silica particles have a dielectric constant of less than 4.0.

2. An optical laminate according to claim 1, wherein the silica particles have a specific surface area of no greater than 2000 m²/g.

3. An optical laminate according to claim 1, wherein the silica particles are amorphous silica particles.

4. An optical laminate according to claim 1, wherein the content of the silica particles is 10-50 parts by mass based on 100 parts by mass of the resin component in the antiglare layer.

5. An optical laminate according to claim 1, which further comprises a low refractive index layer on the antiglare layer.

6. An image display device comprising an optical laminate according to claim 1 on an outermost surface thereof.

7. A polarizing plate provided with a polarizing element, comprising an optical laminate according to claim 1 on the polarizing element surface.

8. (canceled)

9. An image display device comprising a polarizing plate according to claim 7 on an outermost surface thereof.

10. A process for producing an optical laminate with improved optical characteristics, comprising an optically transparent base and an antiglare layer containing silica particles, the process comprising the following steps (a)-(e):
(a) a step of adjusting the dielectric constant of the silica particles to less than 4.0;
(b) a step of dispersing and mixing the silica particles together with a binder resin and other components as desired to prepare an antiglare layer forming composition, the composition having reduced electrostatic attraction between the silica particles and controlled aggregation of the silica particles;
(c) a step of providing an optically transparent base;
(d) a step of coating the antiglare layer forming composition prepared in step (b) onto the optically transparent base to form a coated film; and
(e) a step of drying and curing the coated film to obtain an optical laminate, wherein the obtained optical laminate is provided with superior black reproducibility and antiglare property.

11. A process according to claim 10, wherein in step (a), hollow silica particles are used as the silica particles and the dielectric constant of the silica particles is adjusted to less than 4.0 by varying the void percentage.

12. A process according to claim 10, wherein in step (a), the dielectric constant of the silica particles is adjusted to less than 4.0 by doping the silica particles.

13. A process according to claim 10, wherein in step (a), the dielectric constant of the silica particles is adjusted to less than 4.0 by chemically modifying the surfaces of the silica particles.

14. A process according to claim 13, wherein the surface chemical modification of the silica particles is the hydrophobizing surface chemical treatment using a silicone material.
